(19) United States
(12) Patent Application Publication
(10) Pub. No.: US 2011/0297841 A1
(43) Pub. Date: Dec. 8, 2011

(54) Generalized Focusing And Deflection Utilizing Deformed Conducting Electrodes

(75) Inventors: George J. Caporaso, Livermore, CA (US); Yu-Jiuan Chen, Fremont, CA (US); Steven A. Hawkins, Livermore, CA (US)

(73) Assignee: Lawrence Livermore National Security, LLC

(21) Appl. No.: 13/152,216

(22) Filed: Jun. 2, 2011

Related U.S. Application Data
(60) Provisional application No. 61/350,767, filed on Jun. 2, 2010.

(51) Int. Cl. H01J 1/50

(52) U.S. Cl. 250/396 ML

(57) ABSTRACT

A charged particle focusing and deflection apparatus and system utilizing one or more (i.e. stacked) ring-shaped electrodes which are contorted or deformed to shape a multipole electric field and thereby effect multipole electric focusing and deflection. In particular the ring-shaped electrodes may be used in a high gradient insulator of a particle accelerator, such as a dielectric wall accelerator (DWA).

### CROSS-REFERENCES TO RELATED APPLICATIONS

This application claims the benefit of U.S. Provisional Application No. 61/350,767, filed Jun. 2, 2010 and incorporated by reference herein.

### FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to beam focusing and deflecting systems, such as used in particle accelerators, and in particular to a charged particle focusing an deflection system using deformed conducting electrodes to shape the electric field into multipole fields.

### BACKGROUND OF THE INVENTION

Various efforts have been made to effect steering and/or focusing particle beams in accelerators. These include efforts to control or introduce aberrations, introduce nonlinear focusing for phase mix damping, or other purposes. In the past electrostatic quadrupoles have been introduced into accelerating columns for electrostatic accelerators. In dielectric wall accelerators focusing has been based on alternating phases; positioning the charged bunch on alternate sides of the peak of the accelerating waveform.

### SUMMARY OF THE INVENTION

One aspect of the present invention includes a charged particle focusing and deflection apparatus, comprising: at least one ring-shaped electrode having deformed surfaces so as to produce a multipole electric field.

Generally, the present invention generally pertains to an apparatus and system for focusing and deflecting charged particle beams, such as those accelerated by, for example, a linear induction accelerator such as a dielectric wall accelerator (DWA) or electrostatic accelerator column. The apparatus comprises at least one substantially ring-shaped electrode made of a suitably conducting material, that is contorted or deformed (or is capable of being contorted or deformed) such that the particular orientation of the surfaces of the rings-shaped electrode may produce a multipole electric field. Depending on the type and manner of contortion of deformation, dipoles, quadrupoles, sextupoles and higher order electric multipole fields may be realized. Multiple layers of (similarly or dissimilarly) deformed or deformable ring-shaped electrodes may also be stacked together into modules forming a beam tube therein, and wherein the electrodes are spaced apart such as by a dielectric (e.g. solid or gas). Such stacked structures may be utilized in a high gradient insulator (HGI).

The contorted or deformed ring-shaped electrode structure may be characterized as follows to produce multipole fields. If the axis of the tube is along the z-axis of a cylindrical coordinate system the displacement of a metal conductor (and therefore the shape) in a high gradient insulator initially lying on the x-y plane at z=0 becomes:

$$z ( r , φ ) = Δ {z ( \frac{r}{b} )}^{n} cos ( n [ φ - {φ}_{o} ] ) .$$

where r is the radius measured from the z-axis, b is the inner radius of the high gradient insulator, and Δz is the maximum deviation of the conductor at the inner radius from the z=0 plane. In particular, n=0 corresponds to no distortion, i.e., a flat conductor and conventional high gradient insulator, n=1 corresponds to a dipole or deflecting field, n=2 corresponds to a quadrupole field which is focusing in one plane and defocusing in the other plane, and n=3 generates a sextupole field, and so on for any integer n.

A voltage difference between adjacent conductors will generate an electric field that is in the direction normal to the conducting surfaces. Because of the distortions there will be radial and azimuthal components of electric field at the inner surface of the high gradient insulating tube in addition to the axial component.

An analysis that is valid for either a static applied voltage or one that travels along the tube in the axial direction that satisfied the gradient preservation criterion that the axial extent of the field of the voltage pulse along the wall be at least 3 times the tube radius yields electric fields in the interior of the tube as

$${E}_{x} = \frac{{E}_{o}}{\sqrt{1 + \frac{4 Δ {z}^{2}}{{b}^{2}}}} \frac{2 Δ z}{{b}^{2}} x$$

A particular azimuthal orientation of

$${E}_{y} = - \frac{{E}_{o}}{\sqrt{1 + \frac{4 Δ {z}^{2}}{{b}^{2}}}} \frac{2 Δ z}{{b}^{2}} y$$

the conductor is chosen without loss of generality. Eₒ is the magnitude

$${E}_{z} = \frac{{E}_{o}}{\sqrt{1 + \frac{4 Δ {z}^{2}}{{b}^{2}}}} .$$

of the electric field that exists between adjacent conductors

The concept can also be directly employed to electrostatic columns where conducting electrodes are placed within the inner diameter of an electrically graded, insulating column.

Deformed HGI for n=2, provides a quadrupole field (i.e. performs electric quadrupole focusing an deflection.

Net focusing in both planes can be achieved by the usual technique of rotating subsequent sections by 90 degrees to as to produce a standard alternating gradient focusing system. In addition, adjacent layers or segments may be clocked to achieve a rotating quadrupole field which will also yield focusing in both planes.

In order to extend the utility of the focusing system for ions, lengthening the period of the alternations in proportion to the particle axial velocity may be used to compensate for the reduction in strength of the alternating gradient focusing with velocity.

All of these focusing effects can be achieved by conductors which lie inside high gradient insulators or which lie in the vacuum, i.e., in the interior of a graded insulating column in an electrostatic accelerator. That is, these results can also be realized with conductors that protrude into the interior vacuum space of an insulating beam tube.

In one exemplary application, the deformed structure of the present invention allows the possibility of adding steering and/or focusing to a high gradient insulating column in either a dielectric wall accelerator or electrostatic accelerator column.

A combination of multipoles can also be realized by superposing deformations of different order simultaneously as in

$$z ( r , φ ) = {α}_{n} Δ {z ( \frac{r}{b} )}^{n} cos ( n [ φ - {φ}_{n} ] ) + {α}_{m} Δ {z ( \frac{r}{b} )}^{m} cos ( m [ φ - {φ}_{m} ] ) + …$$

where the alphas are coefficients which describe the relative proportion of the nth and mth multipole fields.

HGI fabrication techniques using contorted ring-shaped electrodes may be achieved by, for example, laminating layers of wavy Conductor(s)s and dielectrics using preformed dies, and casting pre-arranged wavy Conductor(s)s in a suitable dielectric. Also successive layering of unfired ceramic with a conductive coating may be followed by post machining to finished size after firing. This may be achieved by using an inner tube and outer tube with the wavy contour as a guide for shaping the ceramic and applying the coating or conductive ink. The layers would progress down the tube on the master ring with wavy shape. This is somewhat like multilayer ceramic capacitor production methods. Finally, injection molded dielectrics may be plated with conductive or semi-conductive materials.

Various methods of fabricating the ring-shaped electrodes include for example, by plating, by electroforming, by deformation, by flexing, by mechanical articulation, by powdered sintered metal, by direct metal laser sintering, and by chemical etching. And various methods of fabricating the solid dielectric interlayers positioned between the ring-shaped electrodes, include for example, creating the dielectric by injection molding die forming, casting, firing, machining, deformation, selective laser sintering, casting. And various methods of integration the electrodes with the solid dielectric interlayers include for example, integrating by casting, by mechanically fastening, with dielectric by compression, and with dielectric by lamination

### BRIEF DESCRIPTION OF THE DRAWINGS

The accompanying drawings, which are incorporated into and form a part of the disclosure, are as follows.

FIG. 1 is a perspective view of an exemplary embodiment of a charged particle focusing and deflection apparatus of the present invention comprising a single ring-shaped electrode contorted or deformed to produce a quadrupole electric field, for n=2 cm, and Δz=0.42 cm.

FIG. 2 is a perspective view of another exemplary embodiment of a charged particle focusing and deflection apparatus of the present invention comprising a single ring-shaped electrode contorted or deformed to produce a quadrupole electric field, for n=2, and Δz=5 cm.

FIG. 3 is a cross-sectional view taken along line A-A in FIG. 1.

FIG. 4 is a cross-sectional view taken along line B-B in FIG. 1.

FIG. 5 is a cross-sectional view similar to FIG. 3, and illustrating the shaping of an electric field represented by energy vectors to deflect charged particles in a radially outward direction.

FIG. 6 is a cross-sectional view similar to FIG. 3, and illustrating the shaping of an electric field represented by energy vectors to focus charged particles in a radially inward direction.

FIG. 7 is a z-axis axial view of the structure of FIG. 1, illustrating the quadrupole electric field produced by the contorted ring-shaped electrode, for n=2.

FIG. 8 is a perspective view of another exemplary embodiment of a charged particle focusing and deflection apparatus of the present invention comprising a single ring-shaped electrode that is not contorted so as to have a conventional flat washer shape, for n=0, and Δz=0.

FIG. 9 is a perspective view of another exemplary embodiment of a charged particle focusing and deflection apparatus of the present invention comprising a single ring-shaped electrode that is not contorted but is tilted askew of the z-axis to produce a dipole electric field, for n=1.

FIG. 10 is a perspective view of another exemplary embodiment of a charged particle focusing and deflection apparatus of the present invention comprising a single ring-shaped electrode that is contorted or deformed to produce a sextupole electric field, for n=3.

FIG. 11 is a perspective view of another exemplary embodiment of a charged particle focusing and deflection apparatus of the present invention comprising a single ring-shaped electrode that is contorted or deformed to produce a combination of multipoles, in particular for m=1 and n=2.

FIG. 12 is a side view of the embodiment shown in FIG. 11, showing the asymmetry of its structure.

FIG. 13 is a perspective view of another exemplary embodiment of a charged particle focusing and deflection apparatus of the present invention comprising a stack of ring-shaped electrodes each contorted or deformed similarly to produce a quadrupole electric field, for n=2.

FIG. 14 is an axial view of the embodiment shown in FIG. 11, showing the shaping of the electric field in the beam tube.

FIG. 15 is a perspective view of another exemplary embodiment of a charged particle focusing and deflection apparatus of the present invention comprising a stack of ring-shaped electrodes each contorted or deformed similarly to produce a quadrupole electric field, for n=2, and additionally having rods edge-connected to the electrodes to adjust the contortion and deformation.

FIG. 16 is a side view of the embodiment shown in FIG. 15.

FIG. 17 is a schematic view of another embodiment of a charged particle focusing and deflection apparatus of the present invention having multiple rods connected to both the inside and outside edges, to independent contort or deform different radial sections.

FIG. 18 is a schematic view of another embodiment of a charged particle focusing and deflection apparatus of the present invention having multiple modules, each module having a stack of ring-shaped electrodes each contorted or deformed similarly.

FIG. 19 is a schematic view of another embodiment of a charged particle focusing and deflection apparatus of the present invention having multiple ring-shaped electrodes each controlled so as to be independently contortable from other electrodes.

FIG. 20 is a schematic view of a charged particle focusing and deflection apparatus of the present invention integrated into a dielectric wall accelerator DWA).

### DETAILED DESCRIPTION

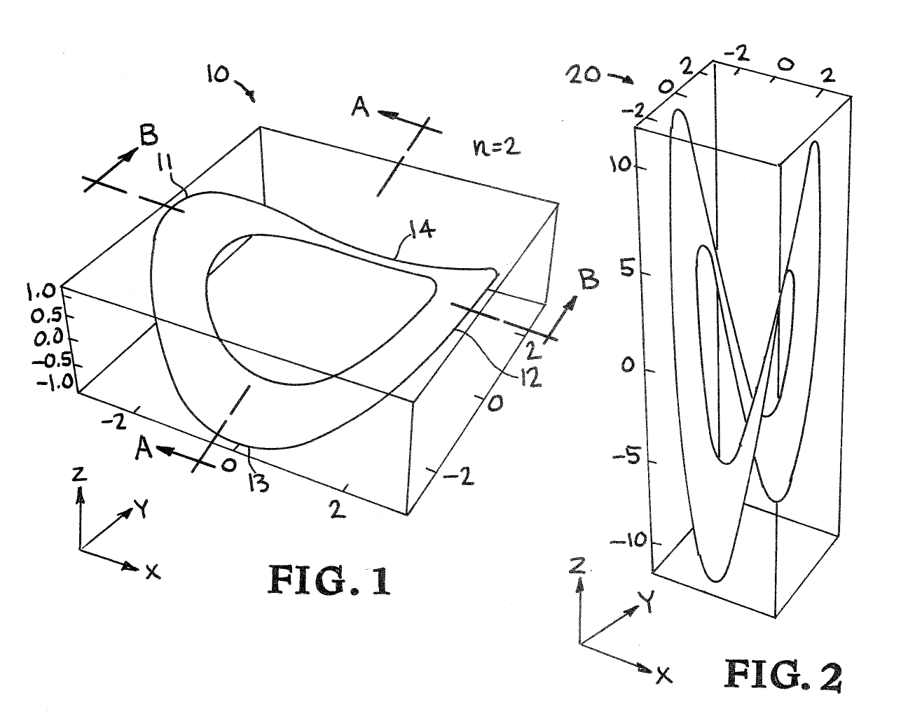

Turning now to the drawings, FIG. 1 is a perspective view of an exemplary embodiment of a charged particle focusing and deflection apparatus of the present invention comprising a single ring-shaped electrode contorted or deformed to produce a quadrupole electric field, for n=2. (has 2 maxima, and 2 minima along z-axis, with b=2 cm, Δz=0.42 cm). For this case, an experimental setup included: proton current=1 Amp, normalized edge emittance=10 πmm-mrad, injection energy=2 MeV, and gradient=100 MV/m.

FIG. 2 is a perspective view of another exemplary embodiment of a charged particle focusing and deflection apparatus of the present invention comprising a single ring-shaped electrode contorted or deformed to produce a quadrupole electric field, for n=2, and Δz=5 cm. Plotted according to the equation, this illustrates a high differential between maxima and minima.

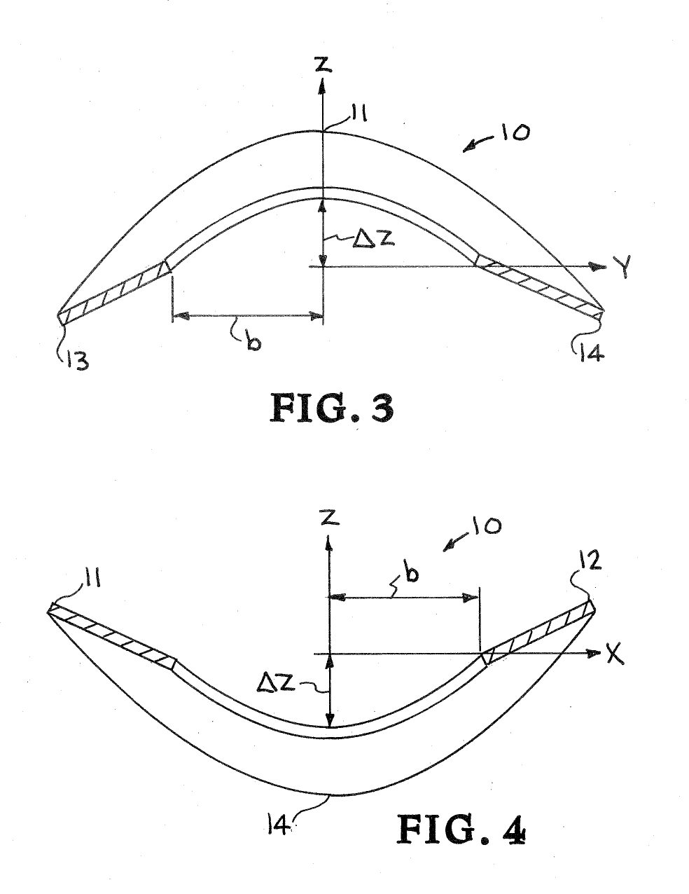

FIG. 3 is a cross-sectional view taken along line A-A in FIG. 1.

FIG. 4 is a cross-sectional view taken along line B-B in FIG. 1.

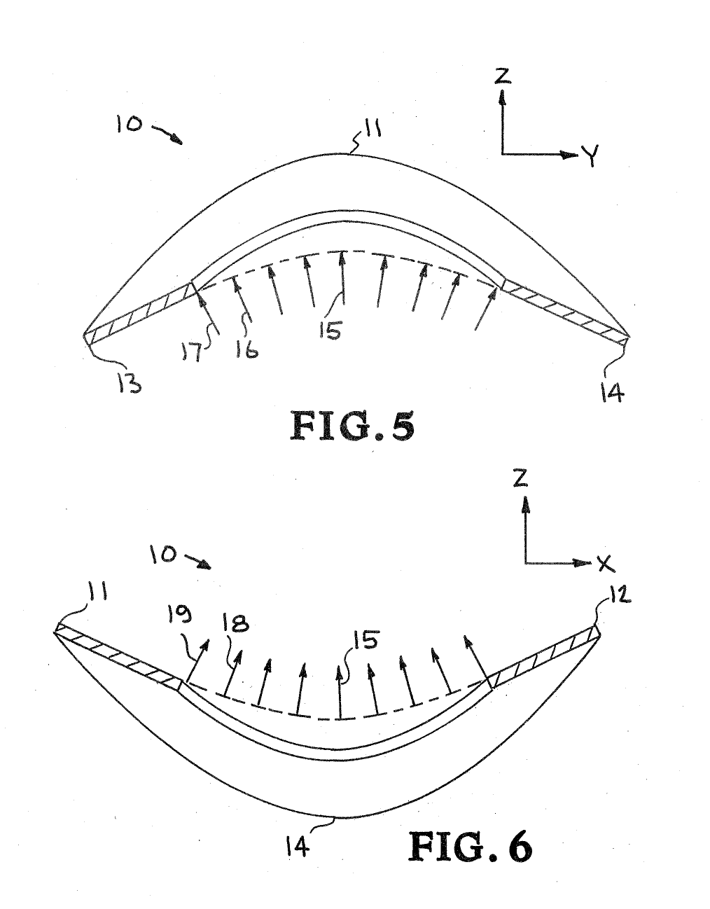

FIG. 5 is a cross-sectional view similar to FIG. 3, and illustrating the shaping of an electric field represented by energy vectors to deflect charged particles in a radially outward direction.

FIG. 6 is a cross-sectional view similar to FIG. 3, and illustrating the shaping of an electric field represented by energy vectors to focus charged particles in a radially inward direction.

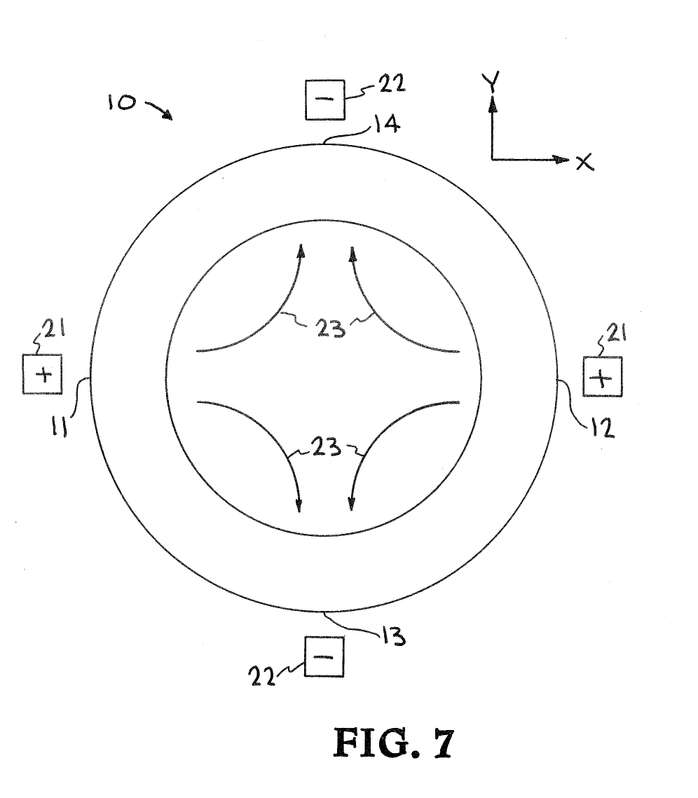

FIG. 7 is a z-axis axial view of the structure of FIG. 1, illustrating the quadrupole electric field produced by the contorted ring-shaped electrode, for n=2.

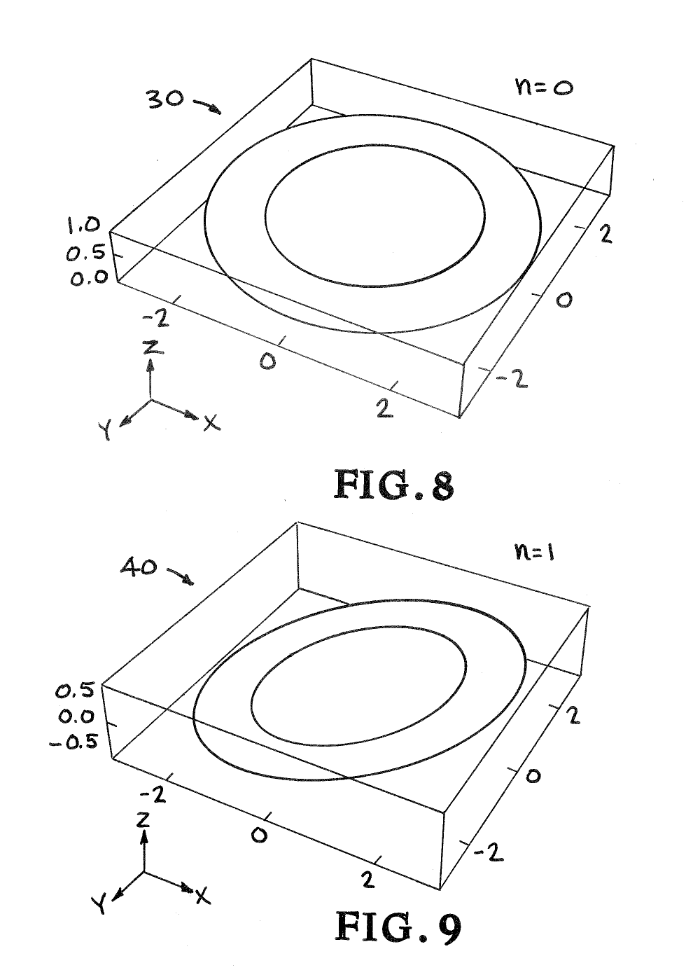

FIG. 8 is a perspective view of another exemplary embodiment of a charged particle focusing and deflection apparatus of the present invention comprising a single ring-shaped electrode that is not contorted so as to have a conventional flat washer shape, for n=0, and Δz=0.

FIG. 9 is a perspective view of another exemplary embodiment of a charged particle focusing and deflection apparatus of the present invention comprising a single ring-shaped electrode that is not contorted or deformed to produce a dipole electric field, for n=1. Thus it has 1 maxima, and 1 minima along z-axis

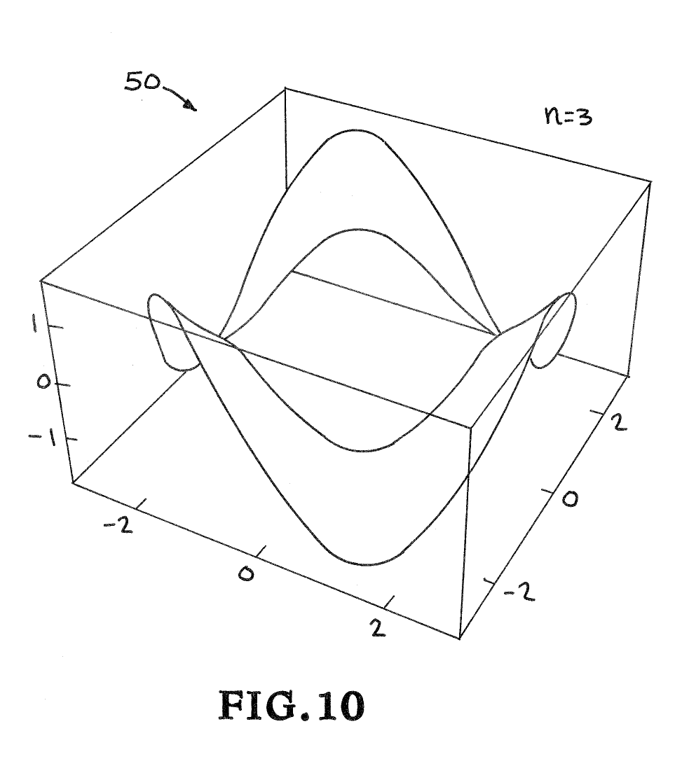

FIG. 10 is a perspective view of another exemplary embodiment of a charged particle focusing and deflection apparatus of the present invention comprising a single ring-shaped electrode that is contorted or deformed to produce a sextupole electric field, for n=3. Thus it has 3 maxima, and 3 minima along the z-axis.

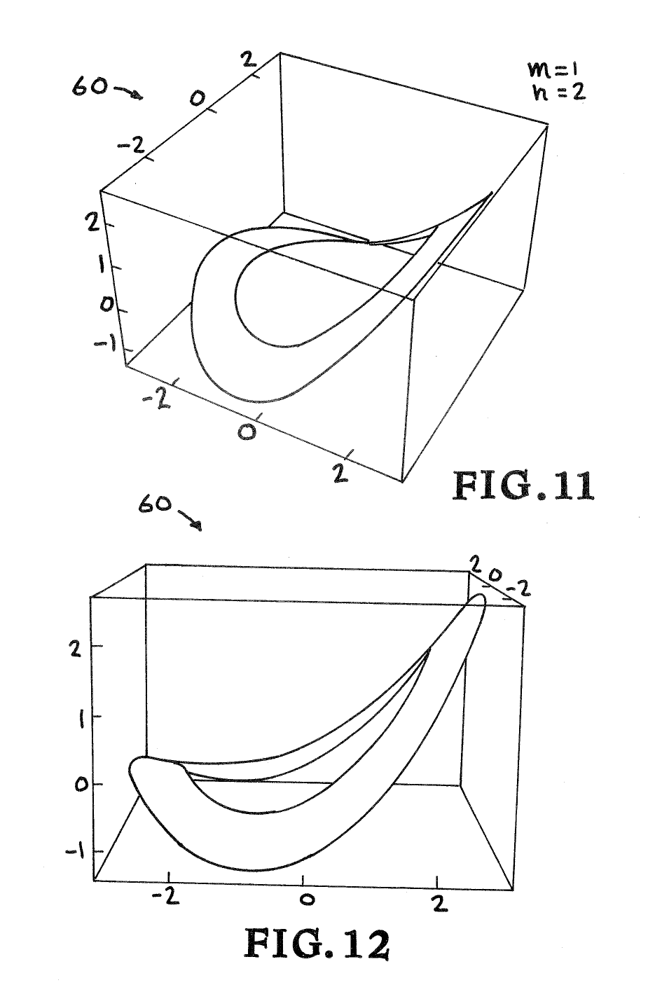

FIG. 11 is a perspective view of another exemplary embodiment of a charged particle focusing and deflection apparatus of the present invention comprising a single ring-shaped electrode that is contorted or deformed to produce a combination of multipoles, in particular for m=1 and n=2.

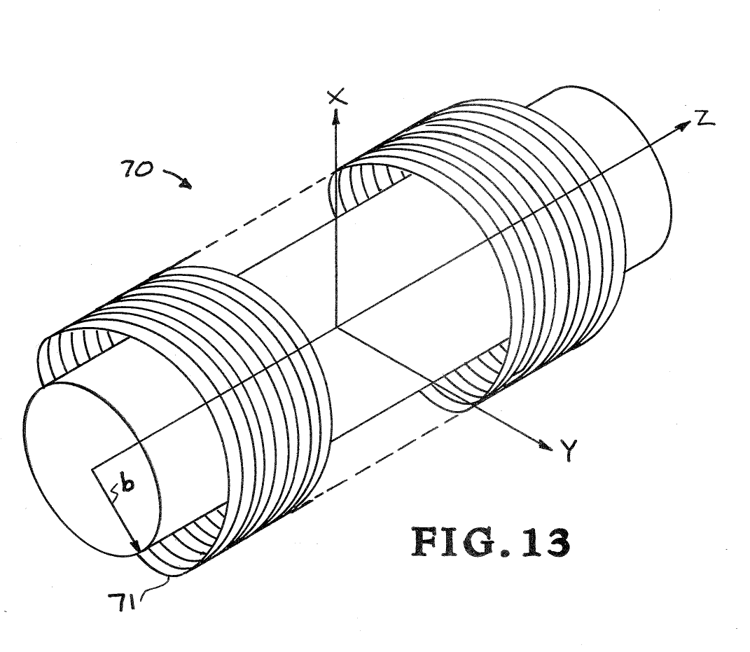

FIG. 12 is a side view of the embodiment shown in FIG. 11, showing the asymmetry of its structure.

FIG. 13 is a perspective view of another exemplary embodiment of a charged particle focusing and deflection apparatus of the present invention comprising a stack of ring-shaped electrodes each contorted or deformed similarly to produce a quadrupole electric field, for n=2.

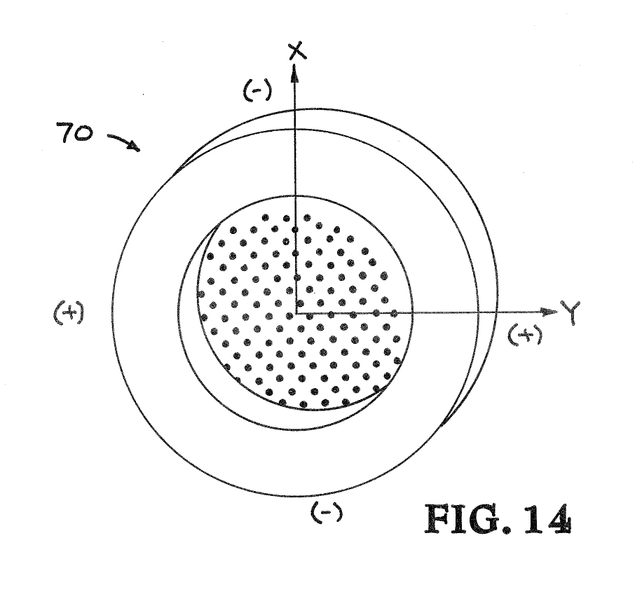

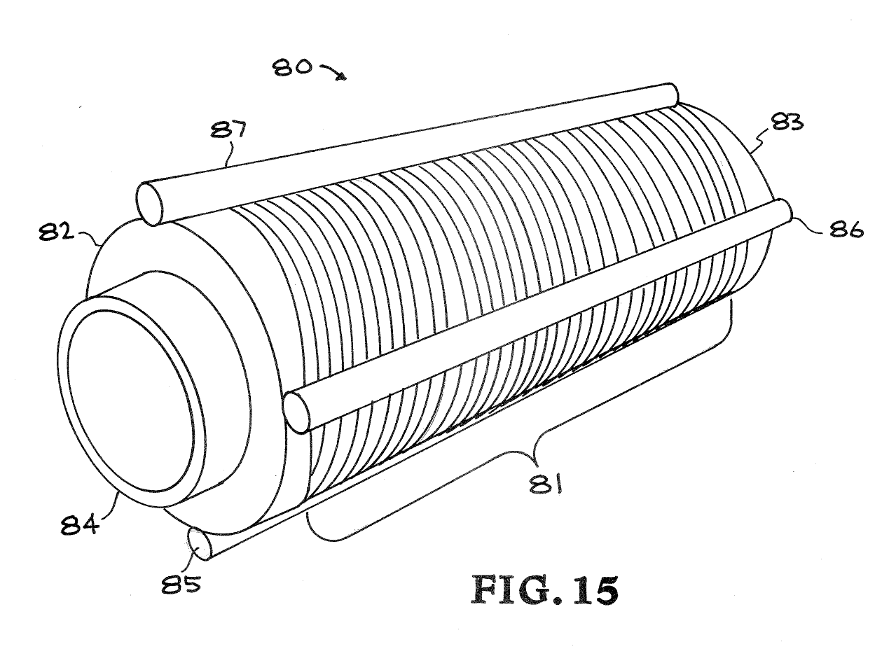

FIG. 14 is an axial view of the embodiment shown in FIG. 11, showing the shaping of the electric field in the beam tube. In particular, FIG. 14 also shows a plot of the transverse electric field calculated from the geometry in FIG. 11, which clearly shows the presence of a quadrupole electric field.

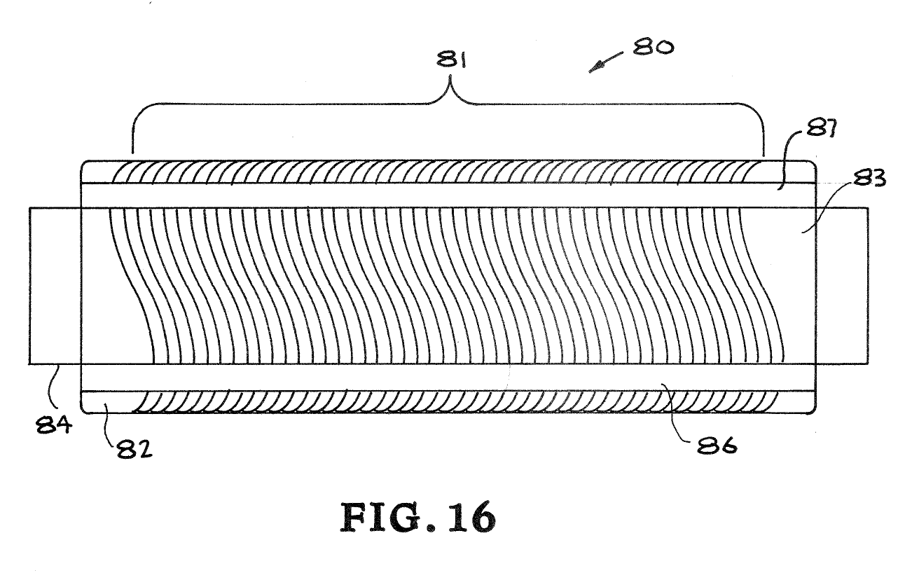

FIG. 15 is a perspective view of another exemplary embodiment of a charged particle focusing and deflection apparatus of the present invention comprising a stack of ring-shaped electrodes each contorted or deformed similarly to produce a quadrupole electric field, for n=2, and additionally having rods edge-connected to the electrodes to adjust the contortion and deformation. The ends are end capped and is also shown with a beam tube (e.g. a vacuum tube).

FIG. 16 is a side view of the embodiment shown in FIG. 15.

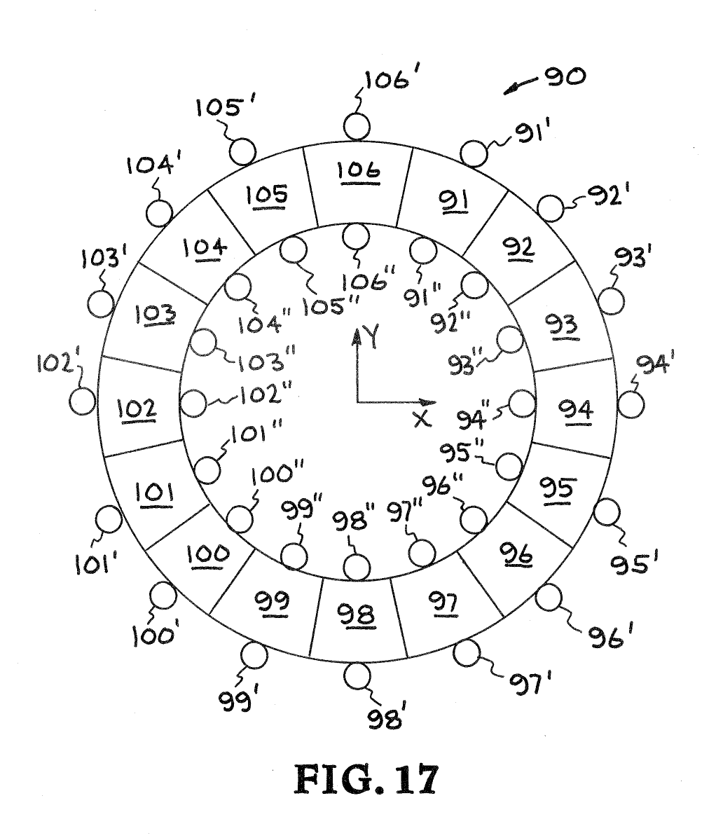

FIG. 17 is a schematic view of another embodiment of a charged particle focusing and deflection apparatus of the present invention having multiple rods connected to both the inside and outside edges, to independent contort or deform different radial sections.

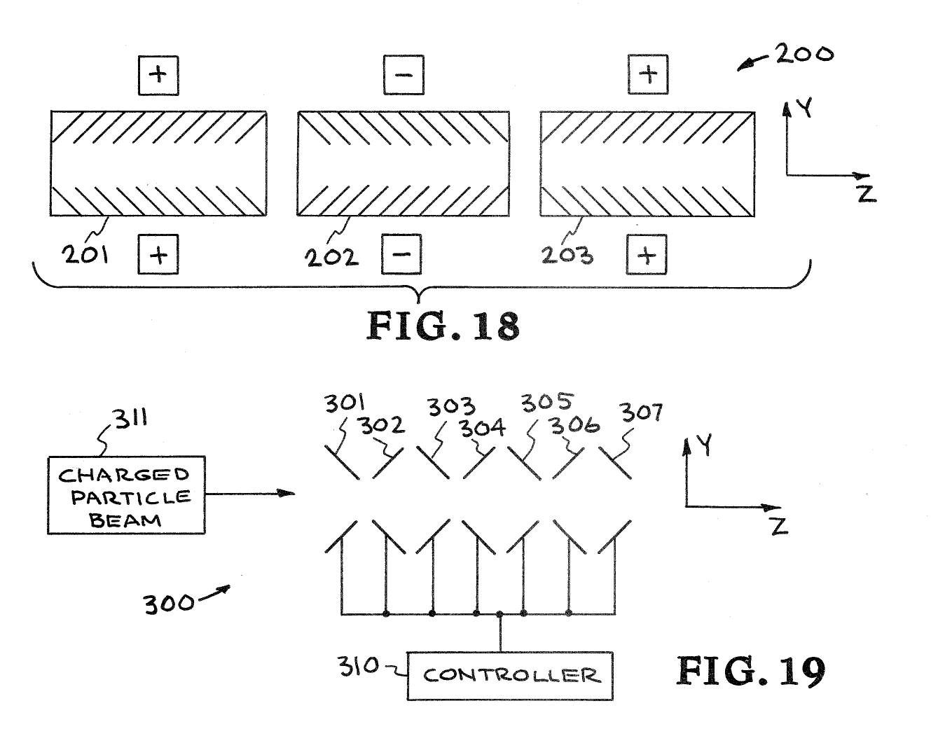

FIG. 18 is a schematic view of another embodiment of a charged particle focusing and deflection apparatus of the present invention having multiple modules, each module having a stack of ring-shaped electrodes each contorted or deformed similarly. Multiple modules may be independently controlled to focus or deflect beam as it travels down the beam path.

FIG. 19 is a schematic view of another embodiment of a charged particle focusing and deflection apparatus of the present invention having multiple ring-shaped electrodes each controlled by a controller so as to be independently contortable from other electrodes.

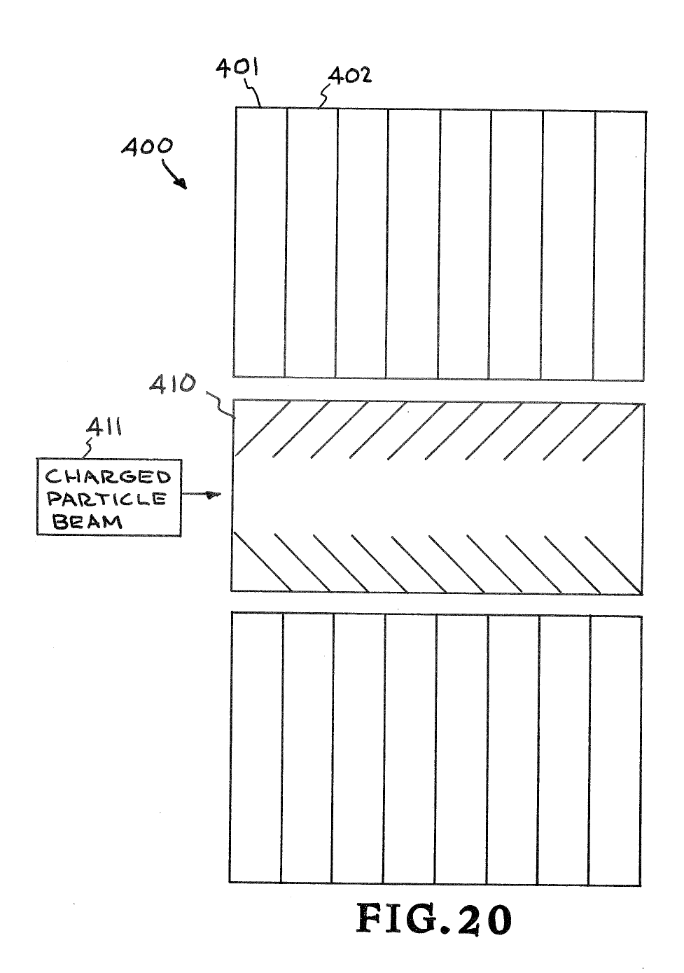

FIG. 20 is a schematic view of a charged particle focusing and deflection apparatus of the present invention integrated into a dielectric wall accelerator DWA) to focus and deflect a charged particle beam.

While particular embodiments and parameters have been described and/or illustrated, such are not intended to be limiting. Modifications and changes may become apparent to those skilled in the art, and it is intended that the invention be limited only by the scope of the appended claims.

We claim:

1. A charged particle focusing and deflection apparatus, comprising:
at least one ring-shaped electrode having deformed surfaces so as to produce a multipole electric field.

2. The apparatus of claim 1,
further comprising at least one additional ring-shaped electrode having similarly deformed surfaces stackes as a single module.

3. The apparatus of claim 1,
further comprising mechanical connectors connecting the multiple electrodes so as to contort them into a different shape.
